(19) United States
(12) Patent Application Publication
(10) Pub. No.: US 2023/0306894 A1
(43) Pub. Date: Sep. 28, 2023

(54) Controller circuit and image processing method

(71) Applicant: NOVATEK Microelectronics Corp., Hsin-Chu (TW)

(72) Inventors: Hui-Feng Lin, Taichung City (TW); Yen-Tao Liao, Hsinchu City (TW)

(73) Assignee: NOVATEK Microelectronics Corp., Hsin-Chu (TW)

(21) Appl. No.: 18/076,411

(22) Filed: Dec. 7, 2022

(30) Foreign Application Priority Data
Mar. 23, 2022 (TW) 111110733

(51) Int. Cl. G09G 3/20; G09G 3/3208

(52) U.S. Cl. CPC G09G 3/2096; G09G 3/2007; G09G 3/3208; G09G 2320/0626; G09G 2320/0666; G09G 2320/0686; G09G 2330/021

(57) ABSTRACT

An image processing method, for processing image data to be displayed by a display panel having a display area being divided into multiple sub-areas, including: determining a power-saving ratio for each sub-area according to a power-saving level; and sequentially adjusting image data of each sub-area in the original image data according to the power-saving ratio corresponding to said sub-area to generate output image data. In the output image data, a characteristic value of the image data corresponding to one of the sub-areas is reduced.

### BACKGROUND OF THE INVENTION

### 1. Field of the Invention

The invention relates to a controller circuit to dynamically adjust a characteristic value of image data according to power-saving mechanism of a system, more particular to a controller circuit for controlling a display panel with no backlight module and capable of dynamically adjusting image data according to power-saving mechanism of a system to adjust a characteristic value of the image data.

### 2. Description of the Prior Art

Organic Light-Emitting Diode (OLED) displays have been widely used in consumer electronic products equipped with thin displays, such as smart phones, tablet computers, or notebook computers due to the advantages of being self-emissive and do not require a backlight, wide viewing angle as 170° or more, fast response speed... etc.. With the rapid development of OLED display technology, OLED displays are more likely to replace Cathode Ray Tube (CRT) and liquid crystal (LCD) screens.

However, for developers of consumer electronic products, how to reduce power consumption is always an important research topic. In particular, as the size of display panel of the consumer electronic products continues to grow in response to user preferences and needs, the power consumed by the display panel will also increase significantly.

### SUMMARY OF THE INVENTION

In view of this, there is a need for a controller circuit of a display panel being capable of dynamically adjusting the image data according to the power-saving mechanism of the system, to achieve good power saving performance.

According to an embodiment of the invention, a controller circuit coupled to a display panel comprises a processor to receive original image data of the display panel and process the original image data to generate output image data. A display area of the display panel is divided into a plurality of sub-areas, the processor determines a power-saving ratio for each sub-area according to a power-saving level and adjust image data corresponding to at least one sub-area in the original image data according to the power-saving ratio corresponding to said at least one sub-area to generate the output image data. In the output image data, a characteristic value of image data corresponding to one of the sub-areas is reduced.

According to an embodiment of the invention, an image processing method, for processing image data to be displayed by a display panel having a display area being divided into a plurality of sub-areas, comprises: determining a power-saving ratio for each sub-area according to a power-saving level; and sequentially adjusting image data corresponding to each sub-area in the original image data according to the power-saving ratio corresponding to said sub-area to generate output image data. On the output image data, a characteristic value of image data corresponding to one of the sub-areas is reduced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a schematic diagram of a display device according to an embodiment of the invention.

FIG. 2 is a schematic diagram showing a display area according to an embodiment of the invention.

FIG. 3 shows a flowchart of an image processing method according to an embodiment of the invention.

FIG. 4 shows an example of setting the power-saving ratios of several power-saving levels according to an embodiment of the invention.

### DETAILED DESCRIPTION

In the application of OLED display, since no backlight module is utilized in the OLED panel, local dimming is unable to be implemented by controlling the backlight module. In addition, since each sub-pixel of the OLED panel is self-illuminating, the luminance of each sub-pixel affects the overall power consumption. In order to effectively control the power consumption of the OLED panel, a novel image processing method and a controller circuit implementing the method to effectively reduce the power consumption of the OLED panel will be introduced in the following paragraphs. In particular, when the electronic product system using the OLED panel is in a low battery status, the image processing method and the corresponding controller circuit effectively reduces the power consumption of the OLED panel without affecting the user’s operation.

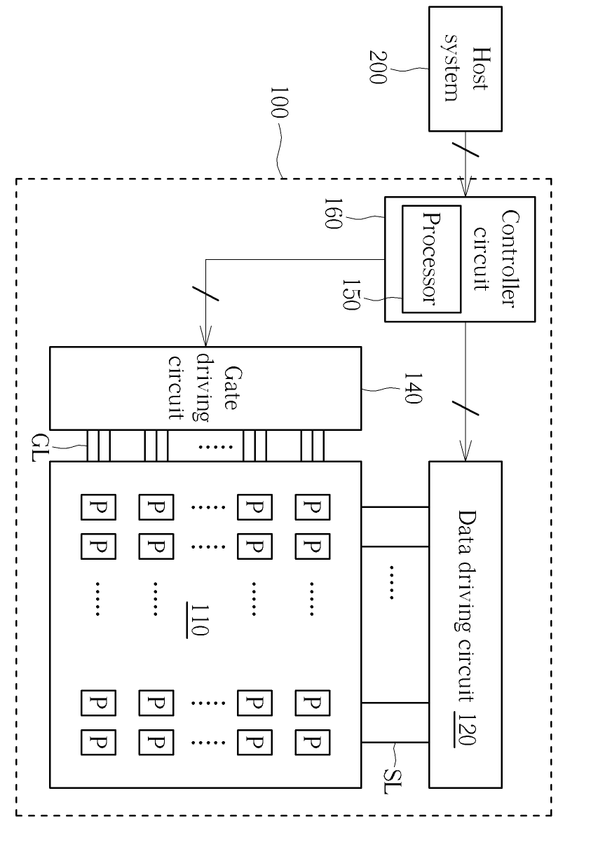

FIG. 1 shows a schematic diagram of a display device according to an embodiment of the invention. The display device 100 may comprise a display panel 110, a data driving circuit 120, a gate driving circuit 140 and a controller circuit 160. The display panel 110 may comprise a plurality of pixel circuits (labeled by ‘P’ in FIG. 1) arranged in a matrix form to display image data. According to an embodiment of the invention, the display panel 110 may be an organic light emitting diode (OLED) panel, wherein each pixel circuit P may comprise at least one organic light emitting diode. In addition, in some embodiments, each pixel circuit P may further comprise a plurality of sub-pixels, for example, sub-pixels for displaying different colors, wherein each sub-pixel may comprise at least one organic light emitting diode.

The gate driving circuit 140 is coupled to the display panel 110 through a plurality of gate lines GL and provides a plurality of gate signals to the display panel 110 under the control of the controller circuit 160 to drive the corresponding pixel circuit P. The data driving circuit 120 is coupled to the display panel 110 through a plurality of data lines SL and provides the image data to be displayed by the display panel 110 to the display panel 110 under the control of the controller circuit 160, wherein the data driving circuit 120 may convert the image data corresponding to each pixel into a voltage signal for driving the corresponding pixel circuit P.

According to an embodiment of the invention, the controller circuit 160 may be a timing controller, to receive input image data and timing signals from the host system 200 and provide the input image data or processed input image data to the data driving circuit 120, and further to control the operation timing of the gate driving circuit 140 and the data driving circuit 120 according to the timing signals. In the embodiment of the invention, the input image data received from the host system 200 may be regarded as the original image data to be displayed by the display panel 110.

According to an embodiment of the invention, the host system 200 may be implemented as a consumer electronic product, such as the aforementioned smart phone, tablet computer, or notebook computer. The host system 200 may be coupled to the display device 100 through a display port or a display interface. For example, the host system 200 may be connected to the display device 100 through an Embedded Display Port (eDP).

According to an embodiment of the invention, the controller circuit 160 may comprise a processor 150. The processor 150 may receive the input image data and the currently set power-saving information from the host system 200. For example, the host system 200 may provide the information of a currently set power-saving level PS_Level through Display Port Configuration Data (DPCD) to the processor 150. The processor 150 may process the original image data according to the aforementioned power-saving information to generate output image data (e.g., the aforementioned processed input image data) to be provided to the data driving circuit 120. It is to be noted that the invention is not limited to the implementation that the power-saving information or the currently set power-saving level PS_Level is provided by the host system 200. In some embodiments of the invention, the power-saving information or the power-saving level PS_Level may also be determined by the controller circuit 160 or the processor 150.

The display panel 110 may comprise a display area, or called an active area. The display area may be the effective display area of the screen of the panel device. According to an embodiment of the invention, the processor 150 may divide the display area into a plurality of blocks, and process image data corresponding to each block in a block-by-block manner according to the aforementioned power-saving information, so as to generate the aforementioned output image data. Compared to directly display the unprocessed original image data, the display panel 110 may have reduced power consumption when displaying the output image data that has been processed.

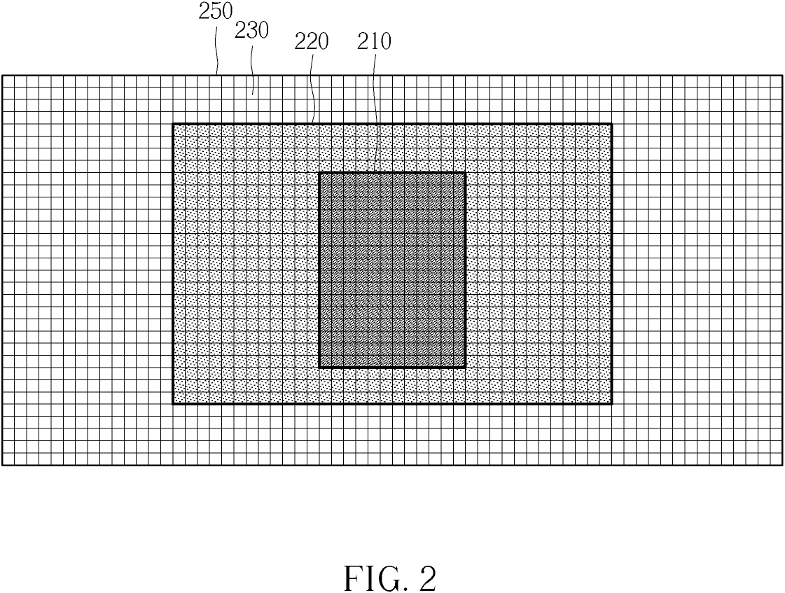

FIG. 2 is a schematic diagram showing a display area according to an embodiment of the invention. In this embodiment, the display area 250 of the display panel may be divided into 64*32 blocks, or called image blocks, wherein the image blocks may have the same size. For example, each image block may be a matrix comprising (M*N) pixels, where M and N are positive integers. In addition, the display area 250 of the display panel may be further divided into a plurality of non-overlapping sub-areas, for example, the sub-areas 210, 220 and 230 shown in FIG. 2. Each sub-area may comprise a plurality of image blocks. The processor 150 may determine a power-saving ratio PS_Ratio corresponding to each sub-area according to the power-saving information or the power-saving level PS_Level, and adjust the image data corresponding to at least one sub-area in the original image data according to the power-saving ratio PS_Ratio corresponding to said at least one sub-area to generate the output image data. Or, the processor 150 may sequentially adjust image data corresponding to each sub-area in the original image data according to the power-saving ratio PS_Ratio corresponding to that sub-area to generate the output image data. The output image data is provided to the display panel 110 and displayed by the display panel 110 in the sub-areas. Through the proposed adjustment, in the output image data, a characteristic value of the image data corresponding to at least one of the sub-areas is reduced.

In the embodiment of the invention, the range and size of the sub-areas may be defined based on power-saving mechanisms of the system, based on the operation currently performed by the user using the electronic product, or based on user preferences, where the power-saving mechanisms may be related to the power-saving needs of the system. In the embodiments of the invention, the sub-areas may be power-saving control areas, and the processor 150 may perform different power-saving controls on different sub-areas, so that the image data corresponding to different sub-areas may have different amount of reductions in the characteristic value. Moreover, in the output image data, the characteristic value of the image data corresponding to one of the sub-areas may be reduced, while the characteristic value of the image data corresponding to another of the sub-areas may remain unchanged.

For example, the sub-area 210 shown in FIG. 2 may be defined as the main area, or the main work area of the user, and the processor 150 may set the power-saving ratio PS_Ratio of the sub-area 210 to the lowest value according to setting of the power-saving information or the power-saving level PS_Level. As an example, 0% of power-saving ratio PS_Ratio means that the processor 150 does not perform any power-saving control on the sub-area 210. Therefore, in the output image data, the characteristic value of the image data corresponding to the sub-area 210 will remain unchanged.

On the other hand, the sub-areas 220 and 230 shown in FIG. 2 may be defined as secondary areas, or secondary work areas of the user, and the processor 150 may, as being started from the center of the panel or the center of the sub-areas 220 and 230, gradually increase the power saving ratio PS_Ratio of the sub-areas 220 and 230 outward according to the power-saving information or the power-saving level PS_Level. For example, the processor 150 may set the power-saving ratio PS_Ratio of the sub-area 220 to another value higher than the power-saving ratio PS_Ratio of the sub-area 210, e.g., set the power-saving ratio PS_Ratio of the sub-area 220 to 30%, and set the power-saving ratio PS_Ratio of the sub-area 230 to another value higher than the power saving ratio PS_Ratio of the sub-area 220, e.g., set the power-saving ratio PS_Ratio of the sub-area 230 to 50%

In some embodiments of the invention, since users usually look at the center of the display panel when operating the electronic product, the distribution of non-overlapping sub-areas or power-saving control areas may be radially spread out from the center of the display panel. However, it is to be noted that the invention is not limited to this design. In other embodiments of the invention, the non-overlapping sub-areas or power-saving control sub-areas may also be arbitrarily divided according to the user preference or some setting value, or may be dynamically divided based on the scope of operating window currently being activated or operated by the user, or based on the scope of operating window frequently being activated or operated by the user.

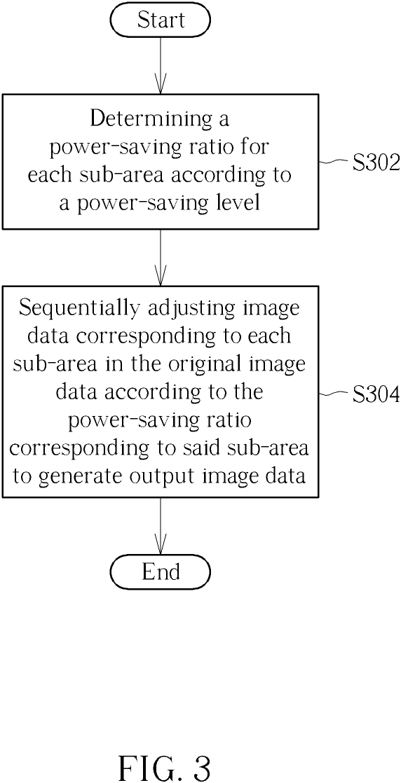

FIG. 3 shows a flowchart of an image processing method according to an embodiment of the invention. The image processing method may comprise the following steps performed by the controller circuit 160:

Step S302: determining a power-saving ratio for each sub-area according to a power-saving level. As mentioned above, the display area of the display panel may be divided into a plurality of non-overlapping sub-areas based on the power-saving mechanisms of the system, the operation currently performed by the user using the electronic product, the scope of operating window currently being activated or operated by the user, or the scope of operating window frequently being activated or operated by the user, or the user preference or some setting value. The controller circuit 160 or the processor 150 may configure a corresponding power-saving ratio for each sub-area according to the currently set power-saving level.

Step S304: sequentially adjusting image data corresponding to each sub-area in the original image data according to the power-saving ratio corresponding to said sub-area to generate output image data, or, adjusting image data in the original image data corresponding to at least one sub-area according to the power-saving ratio corresponding to said at least one sub-area to generate output image data.

In the embodiments of the invention, steps S302 and S304 may be repeatedly performed by the controller circuit 160. For example, when the power-saving information provided by the host system 200 or the power-saving level set by the host system 200 is changed, when the power-saving information or the power-saving level determined by the controller circuit 160 or the processor 150 is changed, or when the content of the display data is updated, the controller circuit 160 may re-perform the image processing method shown in FIG. 3.

According to an embodiment of the invention, the characteristic value may be a luminance value (or, brightness value) of the image data. The processor 150 may adjust the image data or change the characteristic value by adjusting a grayscale value of the original image data, wherein the original image data may be a color image or a grayscale image. According to another embodiment of the invention, the processor 150 may adjust the image data or change the characteristic value by adjusting a color value of the original image data. For example, the original image data may be a color image defined by different color elements (e.g., the red, green, and blue), and the luminance value of the image may be calculated by a linear combination of the color values corresponding to these color elements. For example, the processor 150 may use a gamma curve to convert the grayscale or color values of the image data into luminance values, or inversely derive the grayscale or color values from the settings of luminance values. Therefore, in the embodiments of the invention, for example, in step S304, the processor 150 may adjust the grayscale value or the color value of the image data according to the power-saving ratio.

In practice, the processor 150 may define different sub-areas by setting the corresponding coordinate values, and set the luminance value or the amount of luminance reduction according to the power-saving ratio corresponding to each sub-area. Then, the processor 150 may adjust the image data corresponding to the sub-area in the original image data according to the luminance value or the amount of luminance reduction set for each sub-area, for example, the aforementioned adjustment in the grayscale value or the color value, so as to make the luminance value or the amount of luminance reduction of the image data corresponding to the sub-area to reach the pre-set luminance value or the pre-set amount of luminance reduction.

It is to be noted that, in some embodiments of the invention, there is no need to perform image analysis on the original image data when the processor 150 is performing the image processing method flow as shown in FIG. 3. The processor 150 simply adjusts the image data according to the current power-saving mechanisms. However, the invention is not limited thereto. In other embodiments of the invention, when the processor 150 is performing the image processing method flow as shown in FIG. 3, it may further perform image analysis on the original image data, and adjust the image data according to both the analysis results and power-saving mechanisms to further optimize the adjusted image data.

In the embodiments of the invention, the power-saving level PS_Level set by the processor 150 or the host system 200 may comprise a plurality of levels.

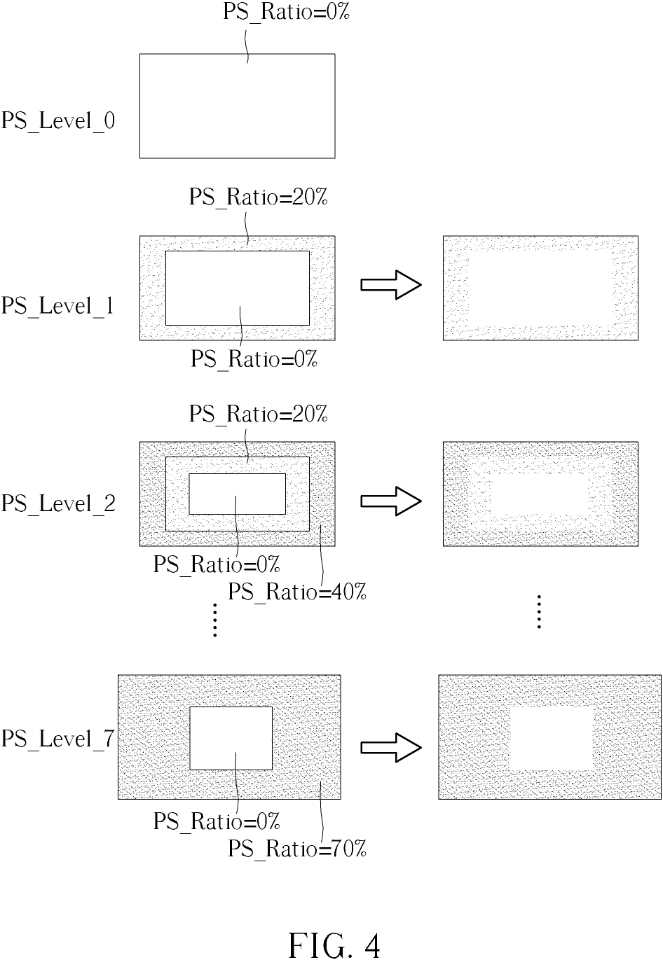

FIG. 4 shows an example of setting the power-saving ratios of several power-saving levels according to an embodiment of the invention. In this example, the power-saving level PS_Level that can be set by the processor 150 or the host system 200 may comprise 8 power-saving levels, such as the power-saving levels PS_Level_0 to PS_Level_7 as shown in FIG. 4. The power-saving level PS_Level_0 may represent a setting that no power-saving is required, that is, the power-saving ratios PS_Ratio of all sub-area may be set to a minimum value, for example, 0% (or equivalent to 100% of the original luminance maintenance ratio). The power-saving levels PS_Level_1~PS_Level_7 may be settings that require power-saving.

For example, the power-saving level PS_Level_1 may correspond to the first operation performed by the user or the first mode of the electronic product, the power-saving level PS_Level_2 may correspond to the second operation performed by the user or the second mode of the electronic product, and so on. In the setting of the power-saving level PS_Level_1, the processor 150 may not perform power-saving on the main area of the screen. Thus, the power-saving ratio PS_Ratio of the main area may be set to the lowest value, for example, 0%, and the processor 150 may only perform power saving on the secondary area other than the main area,. The power-saving ratio PS_Ratio of the secondary area may be set to, for example, 20% (or equivalent to 80% of the original luminance maintenance ratio).

In the setting of the power-saving level PS_Level_2, the processor 150 may further divide the area other than the main area into a plurality of secondary areas, and perform different energy-saving processes on the secondary areas. For example, the power-saving ratios PS_Ratio of the secondary areas may be sequentially set to 20% and 40% (or, equivalent to 80% and 60% of the original luminance maintenance ratio).

In the setting of the power-saving level PS_Level_7, since the power saving level PS_Level_7 may be defined as a super power-saving level, the processor 150 may perform a great scale of power saving on the secondary area. For example, the power saving ratio PS_Ratio of the secondary area may be set as, for example, 70% (or equivalent to 30% of original luminance maintenance ratio).

It is to be noted that the above setting values are only provided as examples for the description, and the invention should not be limited to.

In the embodiments of the invention, the power-saving level PS_Level may be set by the processor 150 or the host system 200 as described above, and may also be manually switched by the user when using the electronic product, or dynamically switched by the processor 150 or the host system 200 according to the current remaining battery level of the electronic product. For example, in an embodiment of the invention, the larger the value of the power-saving level, the greater the amount of power-saving is to be achieved. Therefore, the processor 150 or the host system 200 may gradually switch from the power-saving level PS_Level_0 to the power-saving level PS_Level_1, then to the power-saving level PS_Level_2, ...and so on, according to the current remaining battery level when it is gradually decreasing, and vice versa.

In addition, in the embodiments of the invention, in response to the switching of the power-saving level, the luminance of the display panel may also be changed accordingly. In some embodiments of the invention, the processor 150 may directly adjust the image data according to the new power-saving ratio corresponding to each sub-area in response to the change of the power-saving level, whereby the luminance value of the image data corresponding to each sub-area will immediately change with a corresponding amount of change in response to the change in the power-saving ratio. In another embodiment of the invention, in order to optimize the user experience, when the power-saving level is changed, the luminance change of the display panel may be progressive. For example, the processor 150 may gradually adjust the image data corresponding to each sub-area in a direction from the original power-saving ratio toward the new power-saving ratio in response to the change of the power-saving level, so that it will take some time for the screen luminance of the display panel to reach the new power-saving ratio. For example, the processor 150 may further subdivide the adjustment of the power-saving ratio PS_Ratio from 20% to 40% into a plurality of stages, and slowly increase the amount of luminance reduction of the image data from 20% to 40% in these stages.

According to an embodiment of the invention, in order to achieve a better visual effect, in step S304, the processor 150 may perform a smooth gradation processing between the sub-areas when adjusting the image data corresponding to each sub-area, so as to eliminate the blocking effect at the boundary of the sub-areas and to blur the boundary between the sub-areas. For example, in an embodiment of the invention, the processor 150 may adjust the image data corresponding to a sub-area in the original image data according to the power-saving ratio corresponding to the sub-area, and then perform interpolation on one or more pixels or one or more image blocks located at the boundary of the sub-area or adjacent to the sub-area currently being adjusted, so that the boundary between sub-areas may be blurred. In addition, the processor 150 may also use a low-pass filter to perform filtering on the entire frame of the image data after the interpolation operation, so as to remove the image noise generated in the grayscale value or color value (or, luminance or brightness value) due to the previous adjustment and smooth gradation processing.

In addition, according to an embodiment of the invention, the processor 150 may also set the slope of change in the grayscale value or the color value (or, the luminance value) for the adjacent sub-areas. A large slope means that the adjacent sub-areas may have relatively obvious changes. Therefore, the number of pixels selected by the processor 150 from the pixels nearby the boundary of the sub-area for the interpolation operation may be relatively small. On the contrary, a small slope means that the changes of adjacent sub-areas are relatively gentle. Therefore, the number of pixels selected by the processor 150 from the pixels nearby the boundary of the sub-area for interpolation operation may be relatively large.

In the right side of FIG. 4, the results obtained after applying the corresponding power-saving ratio setting of each power-saving level to the sub-areas and then performing smooth gradation on the image data at the boundary of the sub-areas are shown. Compared with the pictures without the processing of smooth gradation (shown on the left side of FIG. 4), after performing the smooth gradation, the boundaries between sub-areas have become blurred.

According to an embodiment of the invention, as described above, the host system 200 or the processor 150 may divide the display area of the display panel into a plurality of non-overlapping sub-areas, and one of the sub-areas may be defined as the main work area, and the remaining sub-areas may be defined as secondary work areas. In one embodiment of the invention, the main work area may be surrounded by the secondary work area, and the range of the secondary work area may be larger than the main work area. In this way, the display panel may operate in a power-saving mode. In the power-saving mode, most of the power of the electronic product may be reserved for the main work area of the panel, and the luminance of the secondary work area may be reduced according to the image processing method described above, that is, the luminance in the secondary work area will be lower than the luminance in the main work area to save power and extend the time the electronic product can be used before it is recharged.

According to another embodiment of the invention, since the user usually focuses on the center of the display panel, the processor 150 may first generate dark corners at the four corners of the screen, and then decrease the luminance of the four corners of the screen and gradually enlarge the range of the area in which the luminance is decreased as the value of the set power-saving level increases.

In the embodiment of the invention, by applying the image processing method and the corresponding controller circuit, the power consumption of the display panel is reduced without affecting the user’s operation, and the available time to use the electronic product before the electronic product is recharged is prolonged.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A controller circuit, coupled to a display panel, comprising:
a processor to receive original image data of the display panel and process the original image data to generate output image data,
wherein a display area of the display panel is divided into a plurality of sub-areas, the processor determines a power-saving ratio for each sub-area according to a power-saving level and adjust image data corresponding to at least one sub-area in the original image data according to the power-saving ratio corresponding to said at least one sub-area to generate the output image data, and
wherein in the output image data, a characteristic value of image data corresponding to one of the sub-areas is reduced.

2. The controller circuit of claim 1, wherein the display panel is an OLED panel and the characteristic value is a luminance value.

3. The controller circuit of claim 1, wherein the processor adjusts a grayscale value of the original image data to cause the characteristic value to be reduced.

4. The controller circuit of claim 1, wherein the processor adjusts a color value of the original image data to cause the characteristic value to be reduced.

5. The controller circuit of claim 1, wherein in the output image data, a characteristic value of image data corresponding to another of the sub-areas remains unchanged.

6. The controller circuit of claim 1, wherein in the output image data, image data corresponding to different sub-areas have different amount of reductions in the characteristic value.

7. An image processing method, for processing image data to be displayed by a display panel having a display area being divided into a plurality of sub-areas, comprising:
determining a power-saving ratio for each sub-area according to a power-saving level; and
sequentially adjusting image data corresponding to each sub-area in the original image data according to the power-saving ratio corresponding to said sub-area to generate output image data,
wherein in the output image data, a characteristic value of image data corresponding to one of the sub-areas is reduced.

8. The image processing method of claim 7, wherein the display panel is an OLED panel and the characteristic value is a luminance value.

9. The image processing method of claim 7, wherein step of sequentially adjusting image data corresponding to each sub-area in the original image data according to the power-saving ratio corresponding to said sub-area further comprises:
adjusting a grayscale value of the image data according to the power-saving ratio.

10. The image processing method of claim 7, wherein step of sequentially adjusting image data corresponding to each sub-area in the original image data according to the power-saving ratio corresponding to said sub-area further comprises:
adjusting a color level value of the image data according to the power-saving ratio.

11. The image processing method of claim 7, wherein in the output image data, a characteristic value of image data corresponding to another of the sub-areas remains unchanged.

12. The image processing method of claim 7, wherein in the output image data, image data corresponding to different sub-areas have different amount of reductions in the characteristic value.

13. A display panel, comprising:
a display area, comprising a plurality of sub-areas,
wherein a power-saving ratio for each sub-area is determined according to a power-saving level,
image data corresponding to at least one sub-area in original image data of the display panel is adjusted according to the power-saving ratio corresponding to said at least one sub-area to generate output image data of the display panel, and
the output image data is displayed by the display panel in the plurality of sub-areas,
wherein in the output image data, a characteristic value of image data corresponding to one of the sub-areas is reduced.

14. The display panel of claim 13, wherein the characteristic value is a luminance value.

15. The display panel of claim 13, wherein the image data corresponding to said at least one sub-area in the original image data of the display panel is adjusted by adjusting a grayscale value of the original image data.

16. The display panel of claim 13, wherein the image data corresponding to said at least one sub-area in the original image data of the display panel is adjusted by adjusting a color value of the original image data.

17. The display panel of claim 13, wherein in the output image data, a characteristic value of image data corresponding to another of the sub-areas remains unchanged.

18. The display panel of claim 13, wherein in the output image data, image data corresponding to different sub-areas have different amount of reductions in the characteristic value.
